(19) United States
(12) Patent Application Publication
(10) Pub. No.: US 2023/0059361 A1
(43) Pub. Date: Feb. 23, 2023

(54) CROSS-FRANCHISE OBJECT SUBSTITUTIONS FOR IMMERSIVE MEDIA

(71) Applicant: AT&T Intellectual Property I, L.P., Atlanta, GA (US)

(72) Inventors: Eric Zavesky, Austin, TX (US); Richard Palazzo, Stewartville, NJ (US); Wen-Ling Hsu, Bridgewater, NJ (US); Tan Xu, Bridgewater, NJ (US); Mohammed Abdel-Wahab, New York, NY (US)

(21) Appl. No.: 17/408,382

(22) Filed: Aug. 21, 2021

(51) Int. Cl. G06T 11/00; A63F 13/53

(52) U.S. Cl. CPC G06T 11/00; A63F 13/53; A63F 2300/8082

(57) ABSTRACT

In one example, a method performed by a processing system including at least one processor includes rendering an extended reality environment including a first object associated with a first media franchise, identifying a second object to replace the first object in the extended reality environment, wherein the second object is associated with at least one of: the first media franchise or a second media franchise different from the first media franchise, and rendering the second object in the extended reality media in place of the first object.

The present disclosure relates generally to extended reality systems, and relates more particularly to devices, non-transitory computer-readable media, and methods for providing cross-franchise object substitutions for immersive media.

### BACKGROUND

Extended reality is an umbrella term that has been used to refer to various different forms of immersive technologies, including virtual reality (VR), augmented reality (AR), mixed reality (MR), cinematic reality (CR), and diminished reality (DR). Generally speaking, extended reality technologies allow virtual world (e.g., digital) objects to be brought into “real” (e.g., non-virtual) world environments and real world objects to be brought into virtual environments, e.g., via overlays or other mechanisms. Extended reality technologies may have applications in fields including architecture, sports training, medicine, real estate, gaming, television and film, engineering, travel, and others. As such, immersive experiences that rely on extended reality technologies are growing in popularity.

### SUMMARY

In one example, the present disclosure describes a device, computer-readable medium, and method for providing cross-franchise object substitutions for immersive media. For instance, in one example, a method performed by a processing system including at least one processor includes rendering an extended reality environment including a first object associated with a first media franchise, identifying a second object to replace the first object in the extended reality environment, wherein the second object is associated with at least one of: the first media franchise or a second media franchise different from the first media franchise, and rendering the second object in the extended reality media in place of the first object.

In another example, a non-transitory computer-readable medium stores instructions which, when executed by a processing system, including at least one processor, cause the processing system to perform operations. The operations include rendering an extended reality environment including a first object associated with a first media franchise, identifying a second object to replace the first object in the extended reality environment, wherein the second object is associated with at least one of: the first media franchise or a second media franchise different from the first media franchise, and rendering the second object in the extended reality media in place of the first object.

In another example, a device includes a processing system including at least one processor and a computer-readable medium storing instructions which, when executed by the processing system, cause the processing system to perform operations. The operations include rendering an extended reality environment including a first object associated with a first media franchise, identifying a second object to replace the first object in the extended reality environment, wherein the second object is associated with at least one of: the first media franchise or a second media franchise different from the first media franchise, and rendering the second object in the extended reality media in place of the first object.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure may operate;

FIG. 2 illustrates a flowchart of an example method for providing cross-franchise object substitutions for immersive media; and

FIG. 3 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure enhances extended reality environments by providing cross-franchise object substitutions for immersive media. As discussed above, extended reality technologies allow virtual world (e.g., digital) objects to be brought into “real” (e.g., non-virtual) world environments and real world objects to be brought into virtual environments, e.g., via overlays or other mechanisms. Extended reality technologies therefore enable the creation of immersive and personalized experiences, such as video games that can simulate the feeling of a player being physically present in a digitally rendered environment.

As gaming shifts to embrace larger audiences, personalization becomes even more crucial for games seeking to retain player engagement. However, most current gaming platforms are limited to specific platforms and software development kit (SDK) definitions. In such cases, any digital objects created for use in one game on the platform may be shareable across other games on the platform, but the ability to inject arbitrary digital objects across other gaming platforms or franchises may not be possible. Moreover, while some users may have the necessary skills and tools to overwrite or modify a character's or object's default appearance (also referred to as “modding”), this effort is time consuming and may be wasted if the platform does not accommodate the modifications.

Examples of the present disclosure provide a means for users to customize interactive immersive media through the use of licensed content from existing media franchises. In one example, the present disclosure may provide a system by which content from a media franchise (e.g., characters, objects, and other assets belonging to a studio which created the media franchise) may be licensed for use by users in an extended reality environment. Use of the content from the media franchise may be controlled by policies that ensure that use of the content remains consistent with the wishes of the content owner and with the depiction of the content in the original media franchise. In further examples, the system may allow the users to personalize objects in the extended reality environment using the users' own personal media content (e.g., personal photos, videos, etc.). Thus, examples of the present disclosure enable greater personalization and customization of extended reality content while allowing media owners of media properties to leverage their assets in a manner than maintains the integrity of those assets.

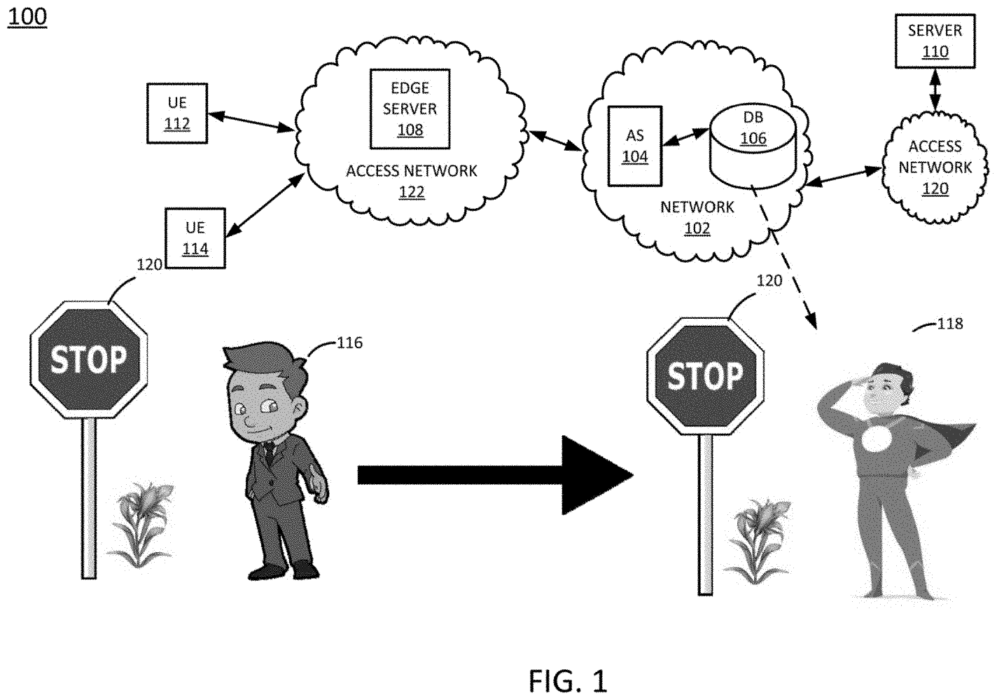

Examples of the present disclosure may be especially useful in immersive gaming platforms, though other use contexts are also possible. Moreover, although examples of the present disclosure are discussed within the context of media franchises (e.g., collections of related media in which several derivative works have been produced from an original creative work, such as a film, a work of literature, a television program, or a video game), the present disclosure is equally applicable to media that is not part of a conventional franchise (e.g., a film or video game that is unrelated to any other films of video games). These and other aspects of the present disclosure are described in greater detail below in connection with the examples of FIGS. 1-3.

To further aid in understanding the present disclosure, FIG. 1 illustrates an example system 100 in which examples of the present disclosure may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, and the like), a long term evolution (LTE) network, 5G and the like related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a network 102, e.g., a telecommunication service provider network, a core network, or an enterprise network comprising infrastructure for computing and communications services of a business, an educational institution, a governmental service, or other enterprises. The network 102 may be in communication with one or more access networks 120 and 122, and the Internet (not shown). In one example, network 102 may combine core network components of a cellular network with components of a triple play service network; where triple-play services include telephone services, Internet or data services and television services to subscribers. For example, network 102 may functionally comprise a fixed mobile convergence (FMC) network, e.g., an IP Multimedia Subsystem (IMS) network. In addition, network 102 may functionally comprise a telephony network, e.g., an Internet Protocol/Multi-Protocol Label Switching (IP/MPLS) backbone network utilizing Session Initiation Protocol (SIP) for circuit-switched and Voice over internet Protocol (VoIP) telephony services. Network 102 may further comprise a broadcast television network, e.g., a traditional cable provider network or an internet Protocol Television (IPTV) network, as well as an Internet Service Provider (ISP) network. In one example, network 102 may include a plurality of television (TV) servers (e.g., a broadcast server, a cable head-end), a plurality of content servers, an advertising server (AS), an interactive TV/video on demand (VoD) server, and so forth.

In one example, the access networks 120 and 122 may comprise broadband optical and/or cable access networks, Local Area Networks (LANs), wireless access networks (e.g., an IEEE 802.11/Wi-Fi network and the like), cellular access networks, Digital Subscriber Line (DSL) networks, public switched telephone network (PSTN) access networks, 3^{rd} party networks, and the like. For example, the operator of network 102 may provide a cable television service, an IPTV service, or any other types of telecommunication service to subscribers via access networks 120 and 122. In one example, the access networks 120 and 122 may comprise different types of access networks, may comprise the same type of access network, or some access networks may be the same type of access network and other may be different types of access networks. In one example, the network 102 may be operated by a telecommunication network service provider. The network 102 and the access networks 120 and 122 may be operated by different service providers, the same service provider or a combination thereof, or may be operated by entities having core businesses that are not related to telecommunications services, e.g., corporate, governmental or educational institution LANs, and the like.

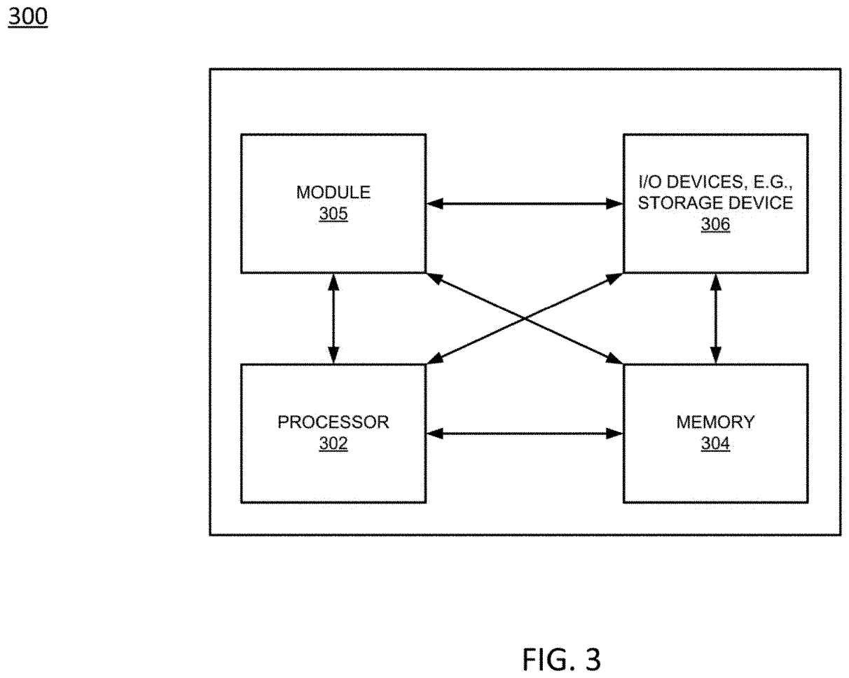

In accordance with the present disclosure, network 102 may include an application server (AS) 104, which may comprise a computing system or server, such as computing system 300 depicted in FIG. 3, and may be configured to provide one or more operations or functions in connection with examples of the present disclosure for providing cross-franchise object substitutions for immersive media. The network 102 may also include a database (DB) 106 that is communicatively coupled to the AS 104.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure. Thus, although only a single application server (AS) 104 and single database (DB) are illustrated, it should be noted that any number of servers may be deployed, and which may operate in a distributed and/or coordinated manner as a processing system to perform operations in connection with the present disclosure.

In one example, AS 104 may comprise a centralized network-based server for generating immersive media (e.g., extended reality environments). For instance, the AS 104 may host an application that renders extended reality environments as part of a user experience for films, video games, and other immersive experiences. The application may be accessible by users utilizing various user endpoint devices. In one example, the AS 104 may be configured to adapt objects from media franchises for cross-franchise object substitutions. For instance, the AS 104 may adapt a character from a super hero film franchise for rendering in a fighting video game franchise.

In one example, AS 104 may comprise a physical storage device (e.g., a database server), to store profiles for various objects, where the objects may include characters, vehicles, and other items depicted in various media franchises. For instance, the AS 104 may store an index, where the index maps each object to a profile containing information about the object which may be used to render the object in an extended reality environment. As an example, an object's profile may contain video, images, audio, and the like of the object's shape, color, make and model (if a vehicle), facial features, body type, clothing or costumes, gait, voice, hand gestures (if a human character), and the like. The profile may also include descriptors that describe how to replicate the appearance and movements of the objects (e.g., special abilities, average speed of gait, pitch of voice, etc.). A profile for an object may also include metadata to assist in indexing and search. For instance, the metadata may indicate the object's identity (e.g., human, animal, vehicle, etc.), media franchise (e.g., video game series, film series, etc.), identifying characteristics (e.g., unique abilities, costume, etc.), pointers (e.g., uniform resource locators or the like) to renderings of the object that have been further modified using features of a user or the user's surrounding environment (as discussed in further detail below), and other data.

A profile for an object may also specify a policy associated with the object. The policy may specify rules or conditions under which the object may or may not be used in cross-franchise media. For instance, the owner of a video game franchise may not want the franchise's characters to be used in games that are made for a competing video game franchise, or the owner of a children's media franchise may not want characters associated with the children's media franchise to be used in media that is violent or that contains strong language. The rules may also specify licensing fees associated with use of the object in other franchises (i.e., other than the original franchise of which the object is a part) where the fees may be based on for how long the object is used (e.g., thirty seconds of use may cost less than ten minutes of use), the context of use (e.g., utilizing the object to modify a personal video may cost less than utilizing the object in a multi-player video game), and/or other considerations.

Media franchises may similarly have profiles that specify the types of objects from other franchises and/or the conditions under which objects from other franchises may be imported. For instance, a video game series based on a comic super hero franchise may be associated with a rule that prevents characters from a competing comic super hero franchise from being used in the video game series. The rules may also specify types of characters and/or character abilities which may be incompatible with a franchise media. For instance, for a media which comprises a simulation of a professional office environment, the rules may prevent users from importing characters from other franchises who possess fictitious abilities (e.g., flying, super speed, etc.).

In one example, the DB 106 may store the index and/or the profiles, and the AS 104 may retrieve the index and/or the profiles from the DB 106 when needed. For ease of illustration, various additional elements of network 102 are omitted from FIG. 1.

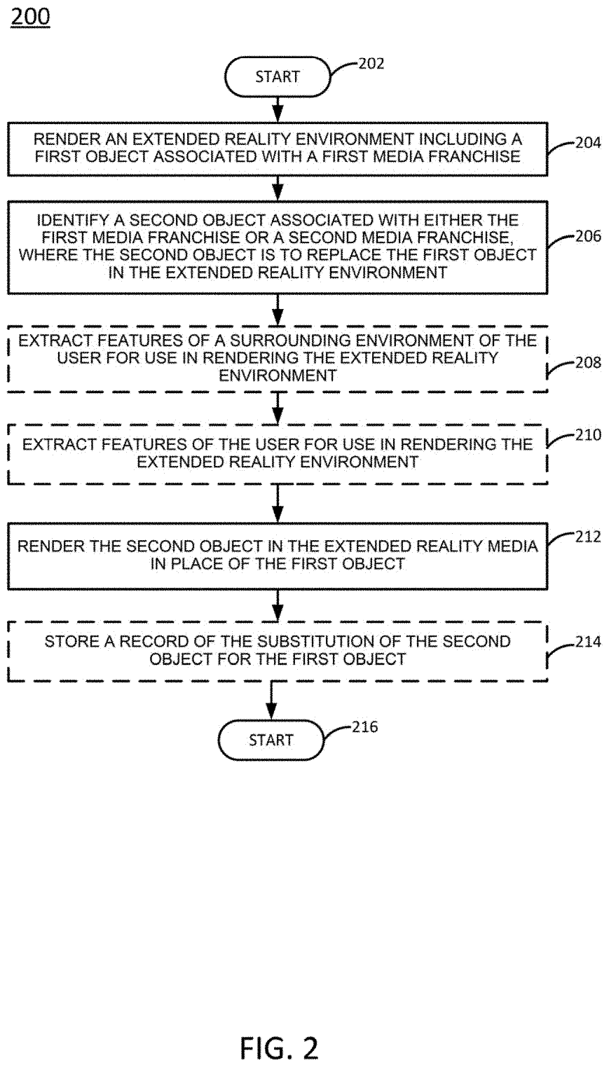

In one example, access network 122 may include an edge server 108, which may comprise a computing system or server, such as computing system 300 depicted in FIG. 3, and may be configured to provide one or more operations or functions for providing cross-franchise object substitutions for immersive media, as described herein. For instance, an example method 200 for providing cross-franchise object substitutions for immersive media is illustrated in FIG. 2 and described in greater detail below.

In one example, application server 104 may comprise a network function virtualization infrastructure (NFVI), e.g., one or more devices or servers that are available as host devices to host virtual machines (VMs), containers, or the like comprising virtual network functions (VNFs). In other words, at least a portion of the network 102 may incorporate software-defined network (SDN) components. Similarly, in one example, access networks 120 and 122 may comprise “edge clouds,” which may include a plurality of nodes/host devices, e.g., computing resources comprising processors, e.g., central processing units (CPUs), graphics processing units (GPUs), programmable logic devices (PLDs), such as field programmable gate arrays (FPGAs), or the like, memory, storage, and so forth. In an example where the access network 122 comprises radio access networks, the nodes and other components of the access network 122 may be referred to as a mobile edge infrastructure. As just one example, edge server 108 may be instantiated on one or more servers hosting virtualization platforms for managing one or more virtual machines (VMs), containers, microservices, or the like. In other words, in one example, edge server 108 may comprise a VM, a container, or the like.

In one example, the access network 120 may be in communication with a server 110. Similarly, access network 122 may be in communication with one or more devices, e.g., user endpoint devices 112 and 114. Access networks 120 and 122 may transmit and receive communications between server 110, user endpoint devices 112 and 114, application server (AS) 104, other components of network 102, devices reachable via the Internet in general, and so forth. In one example, either or both of user endpoint devices 112 and 114 may comprise a mobile device, a cellular smart phone, a wearable computing device (e.g., smart glasses, a virtual reality (VR) headset or other types of head mounted display, or the like), a laptop computer, a tablet computer, or the like (broadly an “XR device”). In one example, either or both of user endpoint devices 112 and 114 may comprise a computing system or device, such as computing system 300 depicted in FIG. 3, and may be configured to provide one or more operations or functions in connection with examples of the present disclosure for simulating likenesses and mannerisms in extended reality environments.

In one example, server 110 may comprise a network-based server for generating extended reality environments. In this regard, server 110 may comprise the same or similar components as those of AS 104 and may provide the same or similar functions. Thus, any examples described herein with respect to AS 104 may similarly apply to server 110, and vice versa. In particular, server 110 may be a component of a system for generating extended reality environments which is operated by an entity that is not a telecommunications network operator. For instance, a provider of an XR system may operate server 110 and may also operate edge server 108 in accordance with an arrangement with a telecommunication service provider offering edge computing resources to third-parties. However, in another example, a telecommunication network service provider may operate network 102 and access network 122, and may also provide an XR system via AS 104 and edge server 108. For instance, in such an example, the XR system may comprise an additional service that may be offered to subscribers, e.g., in addition to network access services, telephony services, traditional television services, media content delivery service, and so forth.

In an illustrative example, an XR system may be provided via AS 104 and edge server 108. In one example, a user may engage an application on user endpoint device 112 to establish one or more sessions with the XR system, e.g., a connection to edge server 108 (or a connection to edge server 108 and a connection to AS 104). In one example, the access network 122 may comprise a cellular network (e.g., a 4G network and/or an LTE network, or a portion thereof, such as an evolved Uniform Terrestrial Radio Access Network (eUTRAN), an evolved packet core (EPC) network, etc., a 5G network, etc.). Thus, the communications between user endpoint device 112 and edge server 108 may involve cellular communication via one or more base stations (e.g., eNodeBs, gNBs, or the like). However, in another example, the communications may alternatively or additional be via a non-cellular wireless communication modality, such as IEEE 802.11/Wi-Fi, or the like. For instance, access network 122 may comprise a wireless local area network (WLAN) containing at least one wireless access point (AP), e.g., a wireless router. Alternatively, or in addition, user endpoint device 112 may communicate with access network 122, network 102, the Internet in general, etc., via a WLAN that interfaces with access network 122.

In the example of FIG. 1, user endpoint device 112 may establish a session with edge server 108 for accessing an application to provide cross-franchise object substitutions for immersive media. For illustrative purposes, immersive media may be an extended reality multi-player online video game. In this regard, a user who is playing the video game may wish to replace their avatar 116 in the extended reality environment 150 with the likeness of a super hero character 118 from a comic franchise. The AS 104 may retrieve a profile for the character 118 and may, if policies associated with the video game and with the character 118 allow, replace the user's avatar 116 in the extended reality environment 150 with the likeness of the character 118. Thus, the user may be able to manipulate the character 118 in the video game to complete tasks, interact with other players, and the like. The character 118 may not only sound like the super hero, but may also sound and move like the super hero and possess one or more unique abilities of the super hero (e.g., flying).

It should also be noted that the system 100 has been simplified. Thus, it should be noted that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of network 102, access networks 120 and 122, and/or Internet may comprise a content distribution network (CDN) having ingest servers, edge servers, and the like for packet-based streaming of video, audio, or other content. Similarly, although only two access networks, 120 and 122 are shown, in other examples, access networks 120 and/or 122 may each comprise a plurality of different access networks that may interface with network 102 independently or in a chained manner. In addition, as described above, the functions of AS 104 may be similarly provided by server 110, or may be provided by AS 104 in conjunction with server 110. For instance, AS 104 and server 110 may be configured in a load balancing arrangement, or may be configured to provide for backups or redundancies with respect to each other, and so forth. Thus, these and other modifications are all contemplated within the scope of the present disclosure.

To further aid in understanding the present disclosure, FIG. 2 illustrates a flowchart of a method 200 for providing cross-franchise object substitutions for immersive media in accordance with the present disclosure. In particular, the method 200 provides a method by which an object belonging to a first media franchise may be substituted with another object belonging to the same media franchise or a different media franchise in an extended reality environment. In one example, the method 200 may be performed by an XR server that is configured to generate extended reality environments, such as the AS 104 or server 110 illustrated in FIG. 1. However, in other examples, the method 200 may be performed by another device, such as the processor 302 of the system 300 illustrated in FIG. 3. For the sake of example, the method 200 is described as being performed by a processing system.

The method 200 begins in step 202. In step 204, the processing system may render an extended reality environment including a first object associated with a first media franchise. The first media franchise may comprise a series of video games, films, television shows, or the like containing a common set of characters and/or objects. For instance the first media franchise may comprise a video game series comprising a plurality of video games that feature the same core set of characters.

Thus, in one example, the extended reality environment may comprise a gaming environment in which multiple users may interact with each other (e.g., playing together or against each other). The gaming environment may further include characters and objects which are specific to the first media franchise (and which include the first object). For instance, the first media franchise may comprise a series of fighting games that depicts a specific set of fighting characters, fighting venues, rewards (e.g., tokens, trophies, etc.), and the like. Thus, the first object in this example might comprise a first fighting character.

In step 206, the processing system may identify a second object associated with either the first media franchise or a second media franchise, where the second object is to replace the first object in the extended reality environment. In one example, the second media franchise is a different media franchise from the first media franchise. Thus, if the first media franchise is a series of fighting games, the second media franchise might comprise a series of platform games, a series of science fiction movies, a super hero television series, or the like. Thus, where the second media franchise is different from the first media franchise, step 206 may involve replacing a character from the first media franchise with a character from the second, different media franchise. However, in other examples, the second object may belong the first media franchise (i.e., the same media franchise as the first object). For instance, where the first media franchise is a series of platform video games, step 206 may involve replacing a playable character in the series of platform video games with a character from the series of platform video games who is not normally playable.

In one example, the second object may be identified based on a signal from a user endpoint device operated by a user in the extended reality environment. For instance, where the extended reality environment comprises a gaming environment, the user may be a person who is participating in the gaming environment as a player. The user may signal to the processing system, using a gaming controller, a head mounted display, or another device, that the user wishes to replace the first object with the second object in the extended reality environment. For instance, the first object may be a character who the user is playing or controlling or who otherwise represents the user in the extended reality environment (e.g., as an avatar), and the user may wish to be represented by a different character, e.g., via a selection from a menu of selectable characters.

In one example, the processing system may prompt the user to indicate the second object in response to the detection of a predefined occurrence in the extended reality environment. In a gaming environment, for example, there may be specific times at which it may be possible or convenient to replace objects. For instance, if the user is about to fight another user in a fighting game, the processing system may prompt the user, just prior to rendering the fight, to finalize a selection of a character to represent the user.

In a further example, the processing system may present the user with a set of candidates from which the user may select the second object. For instance, the processing system may assess the current status of the extended reality environment and may identify one or more suitable objects that may be substituted for the first object, based on context, object availability, device capabilities, and/or other factors. In one example, the processing system may have examined the extended reality environment prior to the rendering (e.g., of step 204) in order to identify times, locations, and/or events that may provide opportunities for substituting objects. For instance, in a gaming environment, the processing system may examine the entire game prior to the user playing the game.

In one example, the one or more suitable objects may include objects that other users have previously utilized at the current point in the extended reality environment. For instance, where the extended reality environment comprises a gaming environment for a fighting game, and a fight between the user and another user is just about to begin, the processing system may identify characters that other users have played or utilized at a similar point in the gaming environment (e.g., just before a fight). In another example, the processing system may extract indicators from the extended reality environment, where the indicators may indicate the compatibility of specific candidate second objects based on cost, availability, and/or other factors. For instance, the indicators may include characteristics of the first object (e.g., appearance, capabilities, voice, mannerisms, catchphrases, skeleton or character rigs that match a body type of a character, and the like) or characteristics of a scene of the extended reality environment in which the first object appears (e.g., appearance, action, context, and the like). These characteristics may be indicated in metadata associated with the first object or with the scene. This metadata may be predefined (e.g., by the developer of the extended reality environment) prior to the rendering, or the metadata may be generated as the extended reality environment is being rendered, by direct examination of the extended reality environment.

Likewise, candidate second objects may be associated with metadata describing the same characteristics. Thus, by matching metadata of a given candidate second object to the first object, the given candidate object may be identified as a potential substitution for the first object. As an example, where the extended reality environment is a gaming environment that includes a fighting game, the first object may comprise a tall fighting character having super strength. A possible candidate second object in this case might be a different character from the second media franchise who also is tall and has super strength.

In another example, the identification of candidate second objects may be limited by the capabilities of the user's endpoint device. For instance, certain objects (e.g., characters having more detailed, high-definition physical appearances) may be more difficult to render realistically on a mobile phone as opposed to a head mounted display. Connectivity between the processing system and the user endpoint device (e.g., connection bandwidth, latency, etc.) may also limit the ability to render certain objects.

In optional step 208 (illustrated in phantom), the processing system may extract features of a surrounding environment of the user for use in rendering the extended reality environment. In one example, the surrounding environment comprises a surrounding real world environment, as opposed to a virtual or extended reality environment. The extracted features may comprise visual features (e.g., images of objects present in the surrounding environment), audio features (e.g., sound clips of sounds that are heard in the surrounding environment), tactile features (e.g., temperature, humidity, wind, etc.) and the like. In one example, the features of the surrounding environment may be extracted using sensors that are in communication with the processing system. For instance, the sensors may be integrated into the user's endpoint device (e.g., a camera, microphone, or thermometer integrated into a mobile phone or head mounted display) or may be distributed throughout the surrounding environment (e.g., mounted on walls, ceilings, columns, or other physical structures of the surrounding environment). In another example, features may be extracted to characterize the physical aspects of the user's surrounding environment (e.g., the shape of a room, the size of a room, availability of free-play space, presence of obstacles, etc.), the properties of physical objects (such as furniture, obstacles, and the like) which are present in the surrounding environment (e.g., design, style, size, and/or color of the objects, and/or aspects of the surrounding environment which may be exploited in modification (e.g., ambient light level, ambient temperature, reflectivity or glare of objects, level of acoustic reverberation from shared walls, etc.). In yet another example, the features of the surrounding environment may be extracted from social media feeds of the user. For instance, if the user's social media activity includes recent postings of photos from the surrounding environment, those photos may be mined for features. Extracting features of the surrounding environment may allow for greater personalization of objects, as discussed in greater detail below.

In optional step 210 (illustrated in phantom), the processing system may extract features of the user for use in rendering the extended reality environment. In one example, the features of the user may be extracted from a profile of the user. The profile of the user may include one or more images of the user (e.g., taken from one or more different perspectives or views, such as a full body image, a front facial image, a profile facial image, different facial expressions, different hair styles, etc.). Features extracted from these images may include features such as eye color, hair color, scars, badges, freckles, prosthetics, eyeglasses, mobility aids, and the like. In one example, the images may include virtual images such as avatars. The images may also include video or moving images, from which additional features (e.g., gait, gestures, etc.) can be extracted. The profile of the user may also include text or metadata indicating one or more characteristics of the user (e.g., age, gender, nationality, occupation, interests, preferences, hobbies, etc.), where any of these characteristics may be extracted as a feature. In a further example, the profile may include audio of the user, from which additional features (e.g., accent, vernacular, slang expressions, speech inflections, etc.) can be extracted. In a further example, some of these features (e.g., vernacular, slang expressions, etc.) can also be extracted from text-based online interactions in the user's online history. Additionally, features extracted from the user's surrounding physical environment may impact one or more characteristics described above, and may therefore modify the rendering of the second object as described below.

In step 212, the processing system may render the second object in the extended reality media in place of the first object. In one example, the processing system may retrieve a profile for the second object that includes renderings (e.g., animated sequences) for various actions, mannerisms, facial expressions, and the like of the second object. In this case, the processing system may select the action, mannerism, facial expression, or the like which best suits the current context of the extended reality environment and/or the current context of the first object. For instance, if the first object comprises a character in a gaming environment who is currently running, then the processing system may utilize a rendering of the second object running to render the second object in the extended reality media.

In some cases, however, the profile for the second object may not include a rendering that is an exact match to the current context of the first object or the extended reality environment. For instance, the first object may comprise a character in a gaming environment who is currently running, but the profile for the second object may not include a rendering of the second object in a running state. In this case, the processing system may superimpose mannerisms of the second object onto a skeleton rig that can be made to run. After superimposing the mannerisms onto the skeleton rig, other physical characteristics of the second object (e.g., hair, face, etc.) may also be superimposed onto the skeleton rig. Alternatively, the processing system may utilize an available rendering of the second object that is the closest match to the current context (e.g., closest match among all renderings available for the second object). For instance, the processing system may utilize a rendering of the object (or subject) walking or skipping.

In one example, the profile for the second object may include images or descriptions of physical features of the second object (e.g., shape, color, make and model if a vehicle, hair and eye color if a human character, etc.). The profile for the second object may also specify any abilities of the second object (e.g., super speed, flying, walking through walls, etc.). In some examples, the abilities of the second object may carry over when the second object is substituted for the first object in the extended reality environment.

In one example, rendering the second object may involve modifying the second object based on at least one of the features of the surrounding environment (as extracted in step 208) or features of the user (as extracted in step 210). In one example, each modification based on the surrounding environment and/or the features of the user may be selectively and individually enabled by the user. For instance, where the second object is a character from a video game series, the user may select an option to change the character's hair color to the user's hair color and to add a pair of glasses worn by the user to the character. Alternatively, where the surrounding environment is snowy, the user may select an option to give the character a hat and mittens.

In another example, rendering the second object may include verifying that the use of the second object (including any additional modifications based on the surrounding environment or features of the user) does not violate any policy of the extended reality environment, the first media franchise, and/or the second media franchise (or said another way, verifying that the use of the second object is in compliance with any use policy of the extended reality environment, the first media franchise, and/or the second media franchise). For example, if the extended reality environment simulates a professional office environment, the extended reality environment may not allow users of the extended reality environment (or their avatars or playable characters) to fly or perform any other actions that may not be feasible in a real office environment. In this case, if the second object is a video game character who can fly, the ability to fly may be disabled by the processing system while the second object is used in the extended reality environment. In another example, a policy of one media franchise (e.g., a first comic book universe) may specify that objects belonging to the media franchise cannot be replaced with objects belonging to another media franchise (e.g., a second competing comic book universe).

In optional step 214 (illustrated in phantom), the processing system may store a record of the substitution of the second object for the first object. The record may include identities of the first object, the second object, and/or the extended reality environment in which the substitution was made. The record may also include any modifications that were made to the second object based on features of the surrounding environment or features of the user. In a further example, the record may include an indication of an amount of time for which the second object was substituted for the first object (where the amount of time may be relevant, for example, to how much money may be owed in licensing fees for the use of the second object).

In one example, the record may be stored in a manner that is accessible to the user. Storing the record may allow the user to re-use the second object (and any possibly modifications) in the extended reality environment at a later time or even on other extended reality environments. Storing the record may also allow the user to share their use of the second object with other users and/or allow other users to select the second object, as modified by the user, for their own use.

In a further example, the record many be stored in a manner that is accessible to the owner of the first object and/or the owner of the second object. Storing the record may allow the owners of media properties to see how their properties (objects) are being used in extended reality environments. Having this information may allow the owners to make more informed decisions when determining how and whether to make modifications to their properties, how and whether to alter any licensing fees associated with use of their properties, how and whether to alter any policies or limitations associated with use of their properties, and the like. For instance, if a given object is frequently being replaced with other objects, the owner of the given object may want to make modifications to the given object to make the given object more desirable to use in the extended reality environment (e.g., if the given object is a video game character, give the video game character more unique or more powerful abilities). If the given object is an object that is frequently replacing other objects, the owner of the given object may want to modify the policies associated with the given object to exert more control of the use of the given object (e.g., if the given object is a video game character associated with a game aimed at children, do not allow reuse of the video game character in violent video games).

The method 200 may end in step 216.

Thus, examples of the present disclosure provide a means for users to customize interactive immersive media through the use of licensed content from existing media franchises. In one example, the present disclosure may provide a system by which content from a media franchise (e.g., characters, objects, and other assets belonging to a studio which created the media franchise) may be licensed for use by users in an extended reality environment. Use of the content from the media franchise may be controlled by policies that ensure that use of the content remains consistent with the wishes of the content owner and with the depiction of the content in the original media franchise. In further examples, the system may allow the users to personalize objects in the extended reality environment using the users' own personal media content (e.g., personal photos, videos, etc.). Thus, examples of the present disclosure enable greater personalization and customization of extended reality content while allowing media owners of media properties to leverage their assets in a manner that maintains the integrity of those assets.

In other words, examples of the present disclosure enable and even encourage a user's desire to create a “mash up” of content from different media franchises in a way that also benefits the owners of the media franchises that are being mashed up. For the developers of the extended reality environments and the content creators, examples of the present disclosure provide a reusable structure for defining specific properties for virtual objects (e.g., a skeleton/body and attributes for a human game character), which allows easier adaptation of the objects to other extended reality environments.

This ability may prove useful in a variety of applications. For instance, examples of the present disclosure may improve user engagement with extended reality video games and/or with characters and objects in the extended reality video games by allowing the users to substitute and personalize the characters and objects. The users may also be able to replay classic video games, which may not have originally been available in an immersive format, in a new extended reality environment for greater immersion. The new extended reality environment may even include objects from the user's current physical environment. By allowing the classic game to be experienced in the new extended reality environment, the main game challenges may be preserved while still providing for a new immersive experience. For instance, where the main game challenge is to solve a mystery in an amusement park, the mystery solving aspect of the game could be preserved but moved to a user's home.

In another example, examples of the present disclosure could be used to improve industrial education (e.g., to find a better solution to a problem). For instance, in an extended reality simulation of a problem, a first character with a first set of abilities could be replaced by a second character with a second set of abilities in order to see which set of abilities provides a more effective or more optimal solution to the problem.

In another example, examples of the present disclosure may improve the ease with which events may be repeated in different extended reality environments. For instance, an event pattern (e.g., constructing an object, climbing up a building, etc.) may be learned in a first extended reality environment and translated into a second extended reality environment.

Although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

FIG. 3 depicts a high-level block diagram of a computing device specifically programmed to perform the functions described herein. For example, any one or more components or devices illustrated in FIG. 1 or described in connection with the method 200 may be implemented as the system 300. For instance, a server (such as might be used to perform the method 200) could be implemented as illustrated in FIG. 3.

As depicted in FIG. 3, the system 300 comprises a hardware processor element 302, a memory 304, a module 305 for providing cross-franchise object substitutions for immersive media, and various input/output (I/O) devices 306.

The hardware processor 302 may comprise, for example, a microprocessor, a central processing unit (CPU), or the like. The memory 304 may comprise, for example, random access memory (RAM), read only memory (ROM), a disk drive, an optical drive, a magnetic drive, and/or a Universal Serial Bus (USB) drive. The module 305 providing cross-franchise object substitutions for immersive media may include circuitry and/or logic for performing special purpose functions relating to the operation of a home gateway or XR server. The input/output devices 306 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for providing cross-franchise object substitutions for immersive media (e.g., a software program comprising computer-executable instructions) can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for providing cross-franchise object substitutions for immersive media (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

1. A method comprising:
rendering, by a processing system including at least one processor, an extended reality environment in an extended reality application, wherein the extended reality environment includes a first object associated with a first media franchise;
identifying, by the processing system, a second object to replace the first object in the extended reality environment, wherein the second object is associated with at least one of: the first media franchise or a second media franchise different from the first media franchise; and
rendering, by the processing system, the second object in the extended reality application such that the second object replaces the first object in the extended reality environment.

2. The method of claim 1, wherein the second object is identified in a signal received from a user endpoint device operated by a user.

3. The method of claim 2, wherein the processing system prompts the user to identify the second object in response to detecting a predefined occurrence in the extended reality environment, wherein the predefined occurrence signifies a time or at a location at which to replace the first object.

4. The method of claim 2, wherein the processing system presents the user with a plurality of candidate second objects prior to the user identifying the second object in the signal.

5. The method of claim 4, wherein an availability of a candidate object as one of the plurality of candidate second objects is based on at least one of: a current context of the extended reality environment, a capability of the user endpoint device, a cost of using the candidate object, a connectivity status between the processing system and the user endpoint device, or a prior use by other users of the candidate object in the extended reality environment.

6. The method of claim 1, wherein the rendering the second object comprises superimposing a mannerism of the second object onto a skeleton rig.

7. The method of claim 6, wherein the rendering the second object further comprises superimposing a physical characteristic of the second object onto the skeleton rig.

8. The method of claim 7, wherein the mannerism and the physical characteristic are stored in a profile of the second object.

9. The method of claim 1, further comprising:
extracting, by the processing system, a feature of a surrounding environment of a user for use in rendering the extended reality environment; and
modifying, by the processing system, the second object based on the feature of the surrounding environment.

10. The method of claim 1, further comprising:
extracting, by the processing system, a feature of a user for use in rendering the extended reality environment; and
modifying, by the processing system, the second object based on the feature of the user.

11. The method of claim 10, wherein the feature of the user is extracted from a profile of the user.

12. The method of claim 10, wherein the modifying comprises modifying an appearance of the second object to exhibit a physical characteristic of the user.

13. The method of claim 1, wherein the rendering the second object comprises verifying that a use of the second object in the extended reality environment is in compliance with any use policy associated with the extended reality environment, the first media franchise, or the second media franchise.

14. The method of claim 1, further comprising:
storing, by the processing system, a record of a substitution of the second object for the first object in the extended reality environment.

15. The method of claim 14, wherein the record includes at least one of: an identity of the first object, an identity of the second object, or an identity of the extended reality environment.

16. The method of claim 15, wherein the record further includes at least one of: a modification made to the second object based on a surrounding environment of a user who has requested the rendering or a modification made to the second object based on a feature of the user.

17. The method of claim 14, wherein the record is stored in a manner that is accessible to a user who has requested the rendering.

18. The method of claim 14, wherein the record is stored in a manner that is accessible to at least one of: an owner of the first object or an owner of the second object.

19. A non-transitory computer-readable medium storing instructions which, when executed by a processing system including at least one processor, cause the processing system to perform operations, the operations comprising:
rendering an extended reality environment in an extended reality application, wherein the extended reality environment includes a first object associated with a first media franchise;
identifying a second object to replace the first object in the extended reality environment, wherein the second object is associated with at least one of: the first media franchise or a second media franchise different from the first media franchise; and
rendering the second object in the extended reality application such that the second object replaces the first object in the extended reality environment.

20. A device comprising:
a processing system including at least one processor; and
a computer-readable medium storing instructions which, when executed by the processing system, cause the processing system to perform operations, the operations comprising:
rendering an extended reality environment in an extended reality application, wherein the extended reality environment includes a first object associated with a first media franchise;
identifying a second object to replace the first object in the extended reality environment, wherein the second object is associated with at least one of: the first media franchise or a second media franchise different from the first media franchise; and
rendering the second object in the extended reality application such that the second object replaces the first object in the extended reality environment.
